(19) United States
(12) Patent Application Publication
(10) Pub. No.: US 2005/0248218 A1
(43) Pub. Date: Nov. 10, 2005

(54) Laminated stator core for a linear motor

(76) Inventor: Robert Schmid, Neunkirchen am Brand (DE)

Correspondence Address: HARNESS, DICKEY & PIERCE, P.L.C., P.O.BOX 8910, RESTON, VA, 20195, US

(21) Appl. No.: 11/119,808

(22) Filed: May 3, 2005

(30) Foreign Application Priority Data
May 4, 2004 (DE) 10 2004 021 973.7

(51) Int. Cl. H02K 41/00

(52) U.S. Cl. 310/12

(57) ABSTRACT

A laminated stator core for a linear motor, in particular for a magnetic levitation transportation system, includes stacked stamped sheet-metal laminates. At least some of the sheet-metal laminates are reliably electrically insulated from one another by an additional measure. By way of example, at least one sheet-metal laminate in the stack is oriented differently in that it has stamped burrs which are in the opposite direction to the stamped burrs on the other sheet-metal laminates. According to another example, an insulation plate is inserted at at least one position between the sheet-metal laminates.

The present application hereby claims priority under 35 U.S.C. §119 on German patent application number DE 10 2004 021 973.7, filed May 4, 2004, the entire contents of which is hereby incorporated herein by reference.

### FIELD OF THE INVENTION

The invention generally relates to a laminated stator core for a linear motor. In particular, it relates to one for a magnetic levitation transportation system, wherein stamped sheet-metal laminates are stacked.

### BACKGROUND OF THE INVENTION

Sheet-metal laminates are produced, for example, from sheet-metal blanks which are coated with at least one insulation layer on one side.

During the stamping of a sheet-metal laminate such as this, material compression occurs on one side. A stamped burr is formed on the other side, on the cut edges. Seen in the direction in which the stamping tooling strikes the metal sheet, this thus results first of all in a flattened area and then in a projecting burr on the cut edge. If sheet-metal laminates such as these are stacked in the same orientation, the burr, in the ideal case, always extends into the free space which is produced by the flattened area on the adjacent sheet-metal laminate.

However, unusually long burrs can be produced as a result of wear of the stamping tools. Electrically conductive links can then be produced via the burrs in the stack. Disturbing, intrinsically closed, current paths are then produced when at least two such links occur.

Current paths such as these interfere with the gap measurement method which is used for magnetic levitation transportation systems and which are used to measure the size of the gap between the vehicle and the track. This conventional gap measurement method measures Eddy currents or magnetic induction. Incorrect measurements can thus occur as a result of closed current paths in the laminated stator core.

In order to avoid measurement errors such as these in the determination of the gap between the vehicle and the track, it has already been proposed for the size of the stamped burrs to be monitored, and/or for the sheet-metal laminates to be deburred after the stamping process. These measures are either not sufficiently reliable, or they are highly costly.

The use of a modified gap measurement method in order to minimize the influence of the closed current paths in the laminated stator core leads to measurement accuracy disadvantages.

### SUMMARY OF THE INVENTION

An embodiment of the invention includes an object of specifying a laminated stator core in which the physical extent of possible closed current paths in the laminated stator core is reliably limited. One aim of this is to considerably reduce the influence on the test equipment for gap measurement.

An object may be achieved according to an embodiment of the invention in that at least some of the sheet-metal laminates may be reliably electrically insulated from one another by an additional measure.

### DETAILED DESCRIPTION OF THE EXAMPLE EMBODIMENTS

In this case of at least one embodiment, the distances between the insulation elements should be considerably shorter than the size of the test equipment for gap measurement. For example, the distances between the insulation elements in the stator core should be considerably less than the diameter of a measurement coil in the test equipment for the gap measurement.

The closed current paths which are then still possible in the laminated stator core may be physically so small that they cannot corrupt the measurement result for the gap measurement.

This may result in an advantage that the size of the gap between the vehicle and the trap can be chosen to be smaller than in the past because, advantageously, only a smaller measurement error than in the past need now be expected. This has an advantageous effect on the entire magnetic levitation transportation system.

By way of an example embodiment, at least one sheet-metal laminate in the stack is oriented differently by having stamped burrs which are in the opposite direction to the stamped burrs on the other sheet-metal laminates.

Thus, a sheet-metal laminate which is oriented differently to its adjacent sheet-metal laminates in the stack is always electrically insulated from one of its neighbors. This is due to the fact that the flattened areas which are created by the compression during the manufacturing process are opposite one another.

On the other hand, it is, however, accepted that the differently oriented sheet-metal laminate will always be conductively connected to its other neighbor. This is because the stamped burrs are opposite one another and touch there.

It is sufficient for insulation between adjacent sheet-metal laminates to be ensured at regular intervals. This does not restrict the advantage of preventing the occurrence of excessively large closed current paths in the laminated core as a result of some of the adjacent sheet-metal laminates always being conductively connected to one another.

This may result in an advantage that the disturbing currents can be reduced or even prevented simply by sorting the sheet-metal laminates.

By way of an example embodiment, one sheet-metal laminate may be in each case oriented differently, at a regular distance from one another, in the stack.

This embodiment in itself may result in the advantage that electrical insulation between sheet-metal laminates that are adjacent there is ensured at this chosen distance. The distance can easily be matched to the requirements for the gap measurement method.

By way of an example embodiment, all of the sheet-metal laminates are manufactured identically, and the sheet-metal laminates which are oriented differently are rotated through 180° about an axis at right angles to the stacking direction, before stacking.

There is, in such an embodiment, no need to therefore provide two differently manufactured types of sheet-metal laminates. The stated advantage may be achieved solely by the stacking method.

According to another example embodiment, an insulation plate is inserted at at least one position between the sheet-metal laminates.

An insulation plate of an embodiment such as this including or even composed of suitable electrically insulating material, which is provided in addition to the insulating layers which may be present, results in the advantage that a stamped burr on one sheet-metal laminate cannot touch the adjacent sheet-metal laminate provided only that the insulation plate is chosen to be sufficiently thick.

This also may result in an advantage that it precludes the formation of closed current paths in the laminated stator core, which would interfere with the gap measurement method.

By way of an example embodiment, one insulation plate may be in each case oriented differently, at a regular distance from one another, in the stack.

In this example embodiment, this restricts the disturbing closed current paths to the size of the distance between two adjacent insulation plates. In this case as well, the distances may be chosen such that the size of the closed current paths cannot interfere with the gap measurement method.

By way of an example embodiment, the number of sheet-metal laminates in the stack may be unchanged, and the at least one insulation plate may be added.

This may result in an advantage that the iron cross section of the laminated stator core is not changed by the insertion of the insulation plates, and/or that the characteristics of the linear motor likewise remain the same, in consequence. The laminated stator core is then higher than in the past, overall, but this does not have a disturbing effect.

As an alternative solution or embodiment, one sheet-metal laminate may always be replaced by an insulation plate. In this case, the height of the laminated stator core remains unchanged.

The laminated stator core according to an embodiment of the invention may result, in particular, in an advantage that no disturbing closed current paths can influence the gap measurement. As such, considerably better gap measurement accuracy may be achieved. This advantageously indicates that a smaller gap can be provided between the vehicle and the track than in the past for the magnetic levitation transportation system, thus improving the operation of the magnetic levitation transportation system.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A laminated stator core for a linear motor, comprising:
stacked stamped sheet-metal laminates, at least some of the sheet-metal laminates being reliably electrically insulated from one another by an additional measure.

2. The laminated stator core as claimed in claim 1, wherein at least one sheet-metal laminate in the stack is oriented differently, including stamped burrs which are in the opposite direction to the stamped burrs on the other sheet-metal laminates.

3. The laminated stator core as claimed in claim 2, wherein one sheet-metal laminate is in each case oriented differently, at a regular distance from one another, in the stack.

4. The laminated stator core as claimed in claim 2, wherein all of the sheet-metal laminates are manufactured identically, and wherein the sheet-metal laminates which are oriented differently are rotated through 180° about an axis at right angles to the stacking direction, before stacking.

5. The laminated stator core as claimed in claim 1, further comprising an insulation plate, inserted at at least one position between the sheet-metal laminates.

6. The laminated stator core as claimed in claim 5, wherein one insulation plate is in each case oriented differently, at a regular distance from one another, in the stack.

7. The laminated stator core as claimed in claim 5, wherein the number of sheet-metal laminates in the stack is unchanged, and the at least one insulation plate is added.

8. A magnetic levitation transportation system comprising the laminated stator core for a linear motor of claim 1.

9. The laminated stator core as claimed in claim 1, wherein the laminated stator core is for a magnetic levitation transportation system.

10. The laminated stator core as claimed in claim 3, wherein all of the sheet-metal laminates are manufactured identically, and wherein the sheet-metal laminates which are oriented differently are rotated through 180° about an axis at right angles to the stacking direction, before stacking.

11. The laminated stator core as claimed in claim 2, further comprising an insulation plate, inserted at at least one position between the sheet-metal laminates.

12. The laminated stator core as claimed in claim 3, further comprising an insulation plate, inserted at at least one position between the sheet-metal laminates.

13. The laminated stator core as claimed in claim 4, further comprising an insulation plate, inserted at at least one position between the sheet-metal laminates.

14. The laminated stator core as claimed in claim 6, wherein the number of sheet-metal laminates in the stack is unchanged, and the at least one insulation plate is added.

15. The laminated stator core as claimed in claim 11, wherein the number of sheet-metal laminates in the stack is unchanged, and the at least one insulation plate is added.

16. The laminated stator core as claimed in claim 12, wherein the number of sheet-metal laminates in the stack is unchanged, and the at least one insulation plate is added.

17. The laminated stator core as claimed in claim 13 wherein the number of sheet-metal laminates in the stack is unchanged, and the at least one insulation plate is added.

18. A laminated stator core for a linear motor, comprising:
a plurality of stacked stamped sheet-metal laminates, at least some of the sheet-metal laminates being electrically insulated from one another.

19. The laminated stator core as claimed in claim 18, wherein at least one sheet-metal laminate in the stack is oriented differently, including stamped burrs which are in the opposite direction to the stamped burrs on the other sheet-metal laminates.

20. The laminated stator core as claimed in claim 19, wherein one sheet-metal laminate is in each case oriented differently, at a regular distance from one another, in the stack.
